(19) United States
(12) Patent Application Publication
(10) Pub. No.: US 2011/0058852 A1
(43) Pub. Date: Mar. 10, 2011

(54) CHARGING DEVICE AND ELECTROPHOTOGRAPHIC IMAGE FORMING APPARATUS INCLUDING THE SAME

(75) Inventors: Hee-moon Jeong, Yongin-si (KR); Kae-dong Back, Yongin-si (KR); Jin-ho Lee, Suwon-si (KR)

(73) Assignee: Samsung Electronics Co., Ltd, Suwon-si (KR)

(21) Appl. No.: 12/876,385

(22) Filed: Sep. 7, 2010

(30) Foreign Application Priority Data
Sep. 8, 2009 (KR) 2009-84435

(51) Int. Cl. G03G 15/02

(52) U.S. Cl. 399/171

(57) ABSTRACT

A charging device and an electrophotographic image forming apparatus including the same. A charging electrode of the charging device includes a porous insulating layer including a plurality of hollow rods vertically formed on a substrate formed of a conductive material, and a conductive nano structure formed in the hollow rods of the porous insulating layer. A grid electrode is supported by a spacer and is separated from the nano structure of the charging electrode. Furthermore, the charging electrode of the charging device may include a plurality of protrusions formed on a substrate, a porous insulating layer formed on the plurality of protrusions, and a conductive nano structure formed in hollow rods of the porous insulating layer.

### CROSS-REFERENCE TO RELATED APPLICATIONS

This application claims priority under 35 U.S.C. §119 from Korean Patent Application No. 10-2009-0084435, filed on Sep. 8, 2009, in the Korean Intellectual Property Office, the disclosure of which is incorporated herein in its entirety by reference.

### BACKGROUND

1. Field of the Invention

The present general inventive concept relates to a charging device and an electrophotographic image forming apparatus including the same, and more particularly, to a charging device using a nano structure and an electrophotographic image forming apparatus including the same.

2. Description of the Related Art

Electrophotographic image forming apparatuses charge a photoreceptor such as a photosensitive drum uniformly, scan a laser beam on the charged photoreceptor to form an electrostatic latent image, make the electrostatic latent image visible by using a toner, thereby forming an image. Electrophotographic image forming apparatuses are used in a digital printer or a digital copying machine.

A charging device that charges such a photoreceptor operates by using a contact method by which a charging member contacts the photoreceptor, or by using a non-contact method by which the charging member does not contact the photoreceptor by using a corona discharge. In a charging device using the contact method using a charging member such as a charging roller, the life-span of the photoreceptor may be reduced due to the contact between the charging member and the photoreceptor. Thus, a non-contact charging device is widely used as an image forming apparatus that requires a long life-span.

The non-contact charging device charges the photoreceptor by using a corona discharge by using a charging wire or a charging pin. The non-contact charging device generates a discharge product such as ozone or a nitrogen oxide during a charging operation. The discharge product is harmful to the human body and thus, the amount of discharge product generated has to be reduced.

### SUMMARY

The present general inventive concept provides a charging device to more uniformly charge a surface of a photoreceptor and to reduce an amount of a discharge product, such as ozone or a nitrogen oxide, generated therefrom, and an electrophotographic image forming apparatus including the same.

Additional aspects and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a charging device including a substrate formed of a conductive material; a porous insulating layer disposed on the substrate and including a plurality of hollow rods vertically formed on the substrate, a nano structure formed in the plurality of hollow rods, having conductivity and electrically and mechanically connected to the substrate, a grid electrode separated from the nano structure, and a spacer to support both ends of the grid electrode.

The substrate may include metal.

A horizontal cross-section of the substrate that is parallel to a surface on which the porous insulating layer is formed may have a rectangular shape in which a length corresponding to a width of an object to be charged in a first direction is relatively long and a width in a second direction that is perpendicular to the first direction is relatively short.

A length of the substrate having the rectangular shape in the first direction may be uniform regardless of a third direction that is perpendicular to the first and second directions and a width of the substrate having the rectangular shape in the second direction may be decreased as it gets closer to a top surface of the substrate in the third direction or may be uniform.

A length of the substrate in the third direction may be equal to or greater than a maximum width of the substrate in the second direction.

The substrate may include a plurality of protrusions protruding from the top surface of the substrate, and the porous insulating layer may be formed on a top surface of each of the plurality of protrusions.

The plurality of protrusions may be arranged in a row in a dotted line at equal intervals.

The plurality of protrusions may be arranged in a plurality of rows in a dotted line at equal intervals and may be alternately arranged between the plurality of neighboring rows.

When the number of rows of the plurality of protrusions is N and a pitch interval between the protrusions in each of the rows is P, the protrusions between the neighboring rows may be alternately arranged at a difference of P/N.

Each of the plurality of protrusions may have a shape in which an area of a surface on which the porous insulating layer is to be formed is equal to or smaller than an area of a surface on which the substrate is to be formed.

The porous insulating layer may be a nanoporous template.

The nanoporous template may be an anodizing alumina template or a polymer nano template.

The nano structure may be a metal nano rod that fills the hollow rods of the porous insulating layer or carbon nanotubes that are grown in the hollow rods of the porous insulating layer.

The nano structure may fill the hollow rods of the porous insulating layer or portions thereof.

The nano structure may be in the shape of a continuous strip on the substrate.

An area of the grid electrode that corresponds to the continuous line shape of the nano structure may be opened.

A group of nano structures may constitute non-continuous islands, and the islands may be arranged in a row on the substrate in a dotted line at equal intervals.

The grid electrode may be connected to the nano structure while passing an area in which the dotted line shape of the nano structure is projected, or while passing a reverse image of the area in which the dotted line shape of the nano structure is projected.

A group of nano structures may constitute non-continuous islands, and the islands may be arranged in a plurality of rows on the substrate in a dotted line at equal intervals, and the islands may be alternately arranged between the neighboring rows.

The spacer may be interposed between the grid electrode and the substrate or between the grid electrode and the porous insulating layer.

The spacer may include an insulating material.

The device may further include at least one grid holder disposed between both ends of the grid electrode and supporting the grid electrode while being inserted or fixed in the substrate.

The device may further include a voltage source applying a charging voltage to the substrate and applying an adjustment voltage to the grid electrode, wherein an absolute value of the adjustment voltage is smaller than an absolute value of the charging voltage.

The foregoing and/or other features and utilities of the present general inventive concept may also be achieved by providing a charging device that charges an object to be charged, the device including a substrate formed of a conductive material, and a plurality of protrusions two-dimensionally arranged on the substrate and having conductivity.

The device may further include: a porous insulating layer disposed on a top surface of each of the plurality of protrusions and including a plurality of hollow rods vertically formed on the top surface of each of the protrusions, and a nano structure formed in the plurality of hollow rods, having conductivity and electrically and mechanically connected to the substrate.

The plurality of protrusions may be arranged in a plurality of rows in a dotted line at equal intervals and may be alternately arranged between the plurality of neighboring rows.

When the number of rows of the plurality of protrusions is N and a pitch interval between the protrusions in each of the rows is P, the protrusions between the neighboring rows may be alternately arranged at a difference of P/N.

Each of the plurality of protrusions may have a shape in which an area of a surface on which the porous insulating layer is to be formed is equal to or smaller than an area of a surface on which the substrate is to be formed.

The substrate may include metal.

The porous insulating layer may be an anodizing alumina template or a polymer nano template.

The nano structure may be a metal nano rod that fills the hollow rods of the porous insulating layer or carbon nanotubes that are grown in the hollow rods of the porous insulating layer.

The foregoing and/or other features and utilities of the present general inventive concept may also be achieved by providing an electrophotographic image forming apparatus including a photoreceptor, a charging device described above and later to charge an outer surface of the photoreceptor, a light scanning unit to scan light onto the outer surface of the photoreceptor to form an electrostatic latent image, and a developing unit to supply a toner to the electrostatic latent image formed on the photoreceptor to develop a toner image.

The foregoing and/or other features and utilities of the present general inventive concept may also be achieved by providing a charging device usable in an image forming apparatus to charge an object, the charging device including a substrate, and a charging electrode formed on the substrate, disposed toward the object, and having tip portions spaced apart from each other to charge the object.

The tip portions of the charging electrode may correspond to a width of a charging area of the object.

The charging device may further include a grid electrode disposed between the object and the tip portions of the charging electrode to control charging uniformity.

The charging device may further include a grid holder to hold and support the grid electrode with respect to the charging electrode.

The charging electrode may include a plurality of nano structures on which the respective tip portions are formed, and the nano structures comprises a first portion formed on the substrate and a second portion extended from the first portion and having an area narrower than the first portion according to a distance from the substrate.

The charging electrode may include a plurality of nano structures on which the respective tip portions are formed, and the nano structures are disposed in a direction perpendicular to a surface of the substrate.

The charging electrode may include a plurality of nano structures on which the respective tip portions are formed, and the plurality of nano structures may be disposed on an area of the substrate, and the area of the substrate may corresponds to a charging area of the object.

The charging electrode may include a plurality of nano structures on which the respective tip portions are formed, and the plurality of nano structures may include a first group of nano structures disposed in a direction and spaced-apart from each other by an interval, and a second group of nano structures disposed in a second direction within the interval.

The charging electrode may include a plurality of nano structures on which the respective tip portions are formed, and the tip portions may include a first group of tip portions disposed in a direction and spaced-apart from each other by an interval, and a second group of tip portions disposed in a second direction within the interval.

The second tip portions may be spaced apart from each other by another interval.

The second group of tip portions may be disposed in an area defined by the adjacent ones of the first group of tip portions and the interval with respect to the second direction.

The object may rotate in a rotation direction and with respect to a rotation axis, and the second direction is disposed between the rotation direction and the rotation axis to increase density of charging characteristic with the interval.

The first direction may be parallel to the rotation axis, and the second direction may not be parallel to the rotation axis and the first direction.

The charging electrode may include an insulation layer, at least two rods formed in the insulation layer and formed with the corresponding tip portions, and nano structures formed in corresponding rods, the insulation layer has a height, and the nano structures have second heights.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a schematic cross-sectional view of a charging device according to an embodiment of the present general inventive concept;

FIG. 2 is a perspective view of the charging device of FIG. 1;

FIG. 3 is a perspective view of a charging electrode disposed in the charging device of FIG. 2;

FIG. 4 is an enlarged view of a region A of FIG. 3;

FIG. 5 illustrates a charging electrode that extends in a continuous line along a lengthwise direction of a substrate, according to an embodiment of the present general inventive concept;

FIG. 6 is an enlarged view of a region B of FIG. 5;

FIG. 7 is a partial perspective view of the region B of FIG. 5;

FIG. 8 is a partial perspective view of a nano structure of a tip portion of the region B of FIG. 5, according to an embodiment of the present general inventive concept;

FIGS. 9A and 9B illustrate a tip portion of the region B of FIG. 5, according to other embodiments of the present general inventive concept;

FIG. 10 is an enlarged view of a region C of FIG. 2;

FIG. 11 is a partial top view of the region C of FIG. 2;

FIG. 12 is an enlarged view of a region D of FIG. 2;

FIG. 13 is a side view of the region D of FIG. 2;

FIG. 14 is a perspective view of a charging electrode disposed in a charging device according to another embodiment of the present general inventive concept;

FIG. 15 is a partial enlarged view of a region E of FIG. 14;

FIG. 16 is a partial enlarged view of a region F of FIG. 15;

FIG. 17 illustrates a protrusion according to an embodiment of the present general inventive concept;

FIG. 18 is a top view of the region E of FIG. 14;

FIG. 19 is a side view of the region E of FIG. 14;

FIG. 20 illustrates the distribution of electric fields between a charging electrode and an object to be charged;

FIG. 21 is a perspective view of a charging electrode disposed in a charging device according to another embodiment of the present general inventive concept;

FIG. 22 is a partial enlarged view of a region G of FIG. 21;

FIG. 23 is a partial enlarged view of a region H of FIG. 22;

FIG. 24 illustrates a protrusion according to an embodiment of the present general inventive concept;

FIG. 25 is a top view of the region G of FIG. 21;

FIG. 26A is a side view of the region G of FIG. 21, and FIG. 26B is a view illustrating arrangement of tip portions; and

FIG. 27 is a schematic view of an electrophotographic image forming apparatus including a charging device, according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. The invention may, however, be embodied in many different forms and should not be construed as being limited to the embodiments set forth herein; rather, these embodiments are provided so that this disclosure will be thorough and complete, and will fully convey the concept of the present general inventive concept to those of ordinary skill in the art. In the drawings, the thicknesses of layers and regions are exaggerated for clarity.

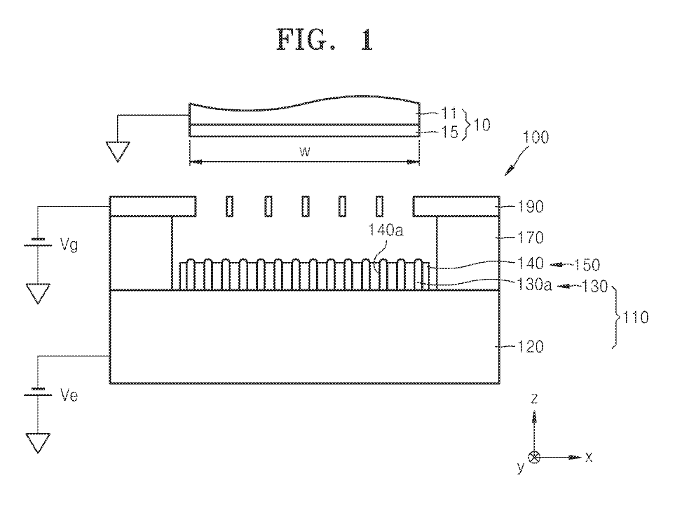

FIGS. 1 through 13 illustrate a charging device according to an embodiment of the present general inventive concept.

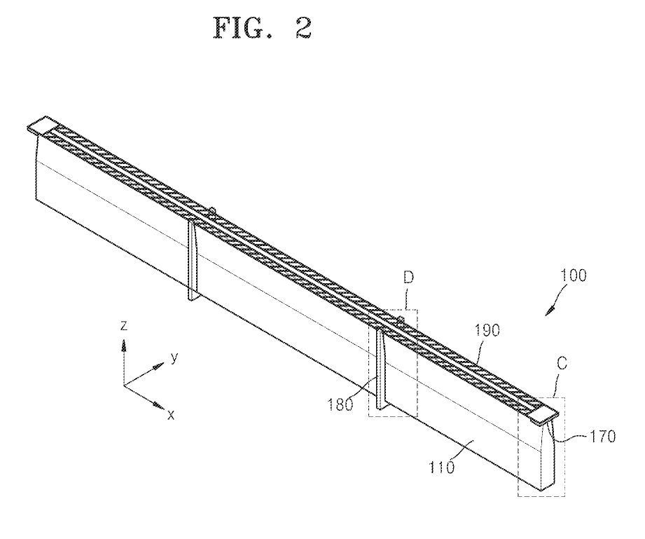

In detail, FIG. 1 is a schematic cross-sectional view of a charging device 100 according to an embodiment of the present general inventive concept, and FIG. 2 is a perspective view of the charging device 100 of FIG. 1. For convenience of explanation, a grid holder is not shown in FIG. 1.

Referring to FIGS. 1 and 2, the charging device 100 according to the present embodiment charges an object 10 in a non-contact state and includes a charging electrode 110 and a grid electrode 190. The charging electrode 110 includes a substrate 120, and a nano structure 130 disposed on the substrate 120 and electrically connected to the substrate 120. The nano structure 130 is formed and supported by a plurality of hollow rods 140a of a porous insulating layer 140. In other words, a tip portion 150 of the charging electrode 110 includes the nano structure 130 and the porous insulating layer 140 that supports the nano structure 130. A spacer 170 and a grid holder 180 are disposed between the charging electrode 110 and the grid electrode 190. The spacer 170 and the grid holder 180 separate the grid electrode 190 from the charging electrode 110.

A material 130a may be filled in the hollow rods 140a to define the nano structure 130. The material 130a may be a conductive material and different from a material of the porous insulating layer 140. The porous insulating layer 140 may have holes, and the material 130a may be filled in the holes to define the hollow rods 140a. It is possible that the hollow rods 140a may be disposed in the holes of the porous insulating layer 140, and the hollow rods 140 may be formed by the material 130a to have a diameter or a thickness to define a hollow space (or cylindrical shape space) therein. It is also possible that the hollow rods 140a may be disposed in the holes of the porous insulating layer 140, and the material 130a may be filled in the hollow space (or cylindrical space) of the hollow rods 140. In this case, the material 130a may be surrounded by the hollow rods 140a and the substrate 120.

A charging voltage source that applies a charging voltage Ve is electrically connected to the charging electrode 110, and an adjustment voltage source that applies an adjustment voltage Vg is electrically connected to the grid electrode 190. An absolute value of the adjustment voltage Vg is smaller than an absolute value of the charging voltage Ve. The object 10 has a structure in which a layer to be charged 15 is formed at an outer circumferential surface of a support 11. The object 10 may be a photoreceptor of an image forming apparatus. In this case, the object 10 is a photosensitive layer, and the support 11 is formed of a conductive metal such as aluminum (Al). The support 11 of the object 10 is grounded or is electrically connected to a voltage source that applies a lower voltage than the charging voltage Ve and the adjustment voltage Vg.

The object 10 may have a width W to correspond to an image which is formed thereon, developed, and transferred to a print medium. Since the forming, developing and transferring of the image are well known, detailed descriptions thereof will be omitted. The width W may correspond to a width of a print medium in a direction perpendicular to a feeding direction of the print medium, that is, an x direction. The object 10 is charged by the charging electrode 110. Since the object 10 rotates about a rotating axis parallel to a first direction x, and the charging electrode 110 has a two dimension in a plane defined by the first direction x and a second direction y, a two dimension surface of the object 10 can be simultaneously and/or continuously charged by the charging electrode 110. The two dimension of the charging electrode 110 may include a length in the first direction x to correspond to the width W of the object.

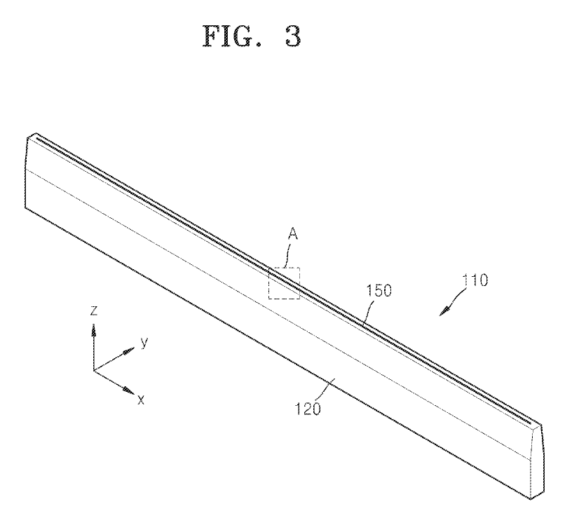

FIG. 3 is a perspective view of the charging electrode 110. Referring to FIG. 3, the substrate 120 that constitutes a body of the charging electrode 110 is formed of a conductive material such as metal, for example, Al.

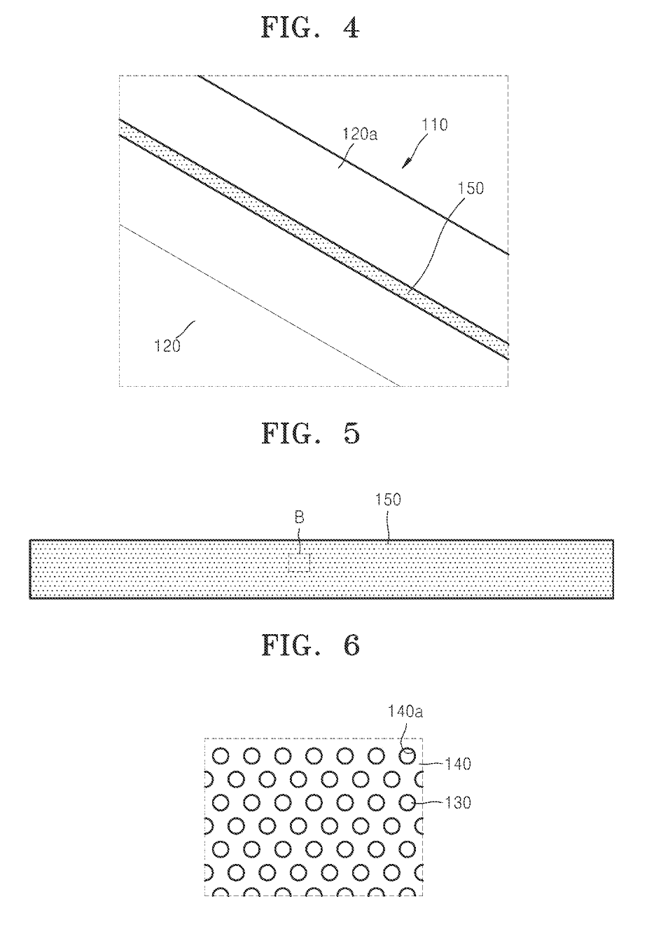

The substrate 120 has a rectangular shape in which a top surface (120a of FIG. 4) of the substrate 120 is relatively long and a width thereof is relatively short. A length of the top surface 120a of the substrate 120 in the first direction x corresponds to a width of the layer to be charged 15 of the object 10. Also, a width of the top surface 120a of the substrate 120 in the second direction y may be several tens of μm to several mm. The substrate 120 may have a horizontal cross-section that is parallel to the top surface 120a and is maintained to have a rectangular shape. In this case, a length of the horizontal cross-section that is parallel to the top surface 120a of the substrate 120 in the first direction x is uniform regardless of a third direction z. Also, the closer to the top surface 120a of the substrate 120, the smaller a width of the horizontal cross-section that is parallel to the top surface 120a of the substrate 120 in the second direction y, or in other words, the width of the horizontal cross-section that is parallel to the top surface 120a of the substrate 120 in the second direction y may be tapered or narrowed as it gets closer to the top surface 120a in the third direction z. Meanwhile, a height of the substrate 120 in the third direction z may be the same as or greater than a maximum width of the cross-section that is parallel to the top surface 120a of the substrate 120. Here, the first direction x, the second direction y, and the third direction z are perpendicular to each other.

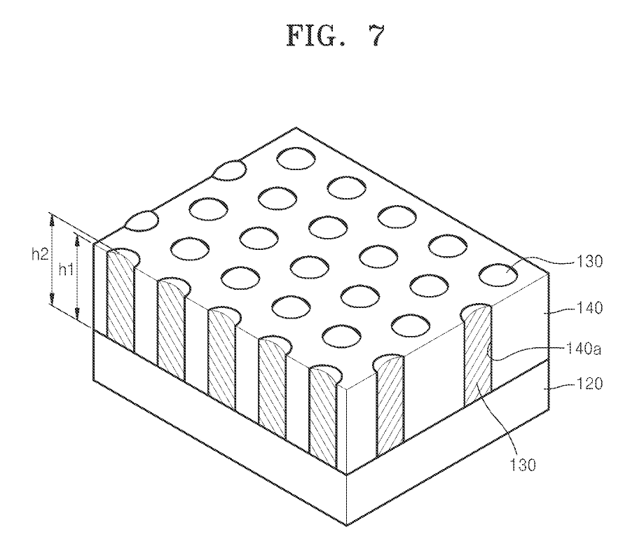

FIG. 4 is a partial enlarged view of a region A of FIG. 3, and FIG. 5 illustrates only the tip portion 150 of the charging electrode 110. FIG. 6 is an enlarged view of a region B of FIG. 5, and FIG. 7 is a partial perspective view of the region B of FIG. 5.

Referring to FIGS. 4 and 5, the tip portion 150 that includes the nano structure 130 and the porous insulating layer 140 may be formed on the top surface 120a of the substrate 120 has a continuous strip shape.

The porous insulating layer 140 includes a plurality of hollow rods 140a that are formed in a direction perpendicular to the substrate 120. The hollow rods 140a of the porous insulating layer 140 are two-dimensionally arranged at regular or irregular intervals when viewed from a top surface of the porous insulating layer 140, as illustrated in FIG. 6. The porous insulating layer 140 may be formed of an insulating material such as an insulating metal oxide, polymer, ceramics, glass or an inorganic material.

The plurality of hollow rods 140a each having a nano size of several nm to several hundreds of nm may be formed on the porous insulating layer 140 by using various general methods. For example, a nanoporous template including a plurality of hollow rods each having a diameter of several nm to several hundreds of nm may be formed by using a self-assembling method of forming a self-aligned nano structure. The nanoporous template may be an anodizing alumina template or a polymer nano template. In addition, the porous insulating layer 140 may also be formed by using a photolithography technology or a nano imprinting technology.

When an anodizing alumina template is used to form the porous insulating layer 140, all portions or portions of the top surface 120a of the substrate 120 formed of Al are oxidized so that the substrate 120 and the porous insulating layer 140 may be formed as one body. Generally, a barrier layer is formed on the bottom of a hole of the anodizing alumina template. The barrier layer is removed by dry etching so that the hollow rods 140a of the porous insulating layer 140 may be perforated and the substrate 120 may be exposed to the outside via the hollow rods 140a.

As another example, when the porous insulating layer 140 is formed of a polymer nano template, the porous insulating layer 140 is separately formed from the substrate 120 and is bonded to the substrate 120.

The nano structure 130 may be formed of a conductive material and is rod-shaped in the plurality of hollow rods 140a of the porous insulating layer 140. A material that is grown in a hollow hole of a nanoporous template and has conductivity may be used to form the nano structure 130. For example, the nano structure 130 may be formed by filling a conductive metal such as copper (Cu), nickel (Ni) or a nickel chrome alloy in the hollow rods 140a of the porous insulating layer 140 by using electroplating. The nano structure 130 may be formed by growing a material in the hollow hole of the nanoporous template or by growing carbon nanotubes.

As described above, the bottom surface of the hollow rods 140a of the porous insulating layer 140 may be removed so that the nano structure 130 directly contacts the substrate 120 via the hollow rods 140a of the porous insulating layer 140. Thus, the nano structure 130 is electrically connected to the substrate 120. The nano structure 130 may serve as an electrode in which a corona discharge is incurred and may be protected mechanically and electrochemically due to the porous insulating layer 140.

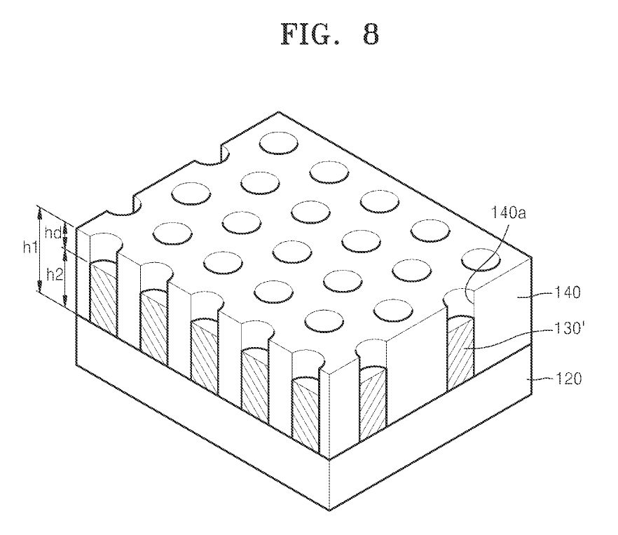

The nano structure 130 may be formed by filling a material in each of the hollow rods 140a of the porous insulating layer 140 or may protrude from the hollow rods 140a, as illustrated in FIG. 7. As occasion demands, a nano structure 130′ may be formed by filling a material only in portions of each of the hollow rods 140a of the porous insulating layer 140, as illustrated in FIG. 8. The tip portion 150 is in the shape of a continuous strip. However, the present invention is not limited thereto, and the tip portion 150 may have various shapes.

Referring to FIG. 7, the porous insulating layer 140 may have a height h1, and the nano structure 130 may have a height h2. The height h1 and the height h2 may be same. It is possible that the height h1 and the height h2 are different. The holes of the porous insulating layer 140 may be different shape from the hollow rods 140a or the nano structure 130. And the tip portion 150 may protrude from a surface of the porous insulating layer 140 in the third direction z. When a material is filled only in portions of each of the hollow rods 140a of the porous insulating layer 140 to form the nano structure 130, the nano structure 130′ may be formed by a first portion made of the material with a height h2 and a second portion made of another material with a height of hd with respect to a height h1 of the hole (or the hollow rod 140a). The another material may be an empty space which is not filled with the material.

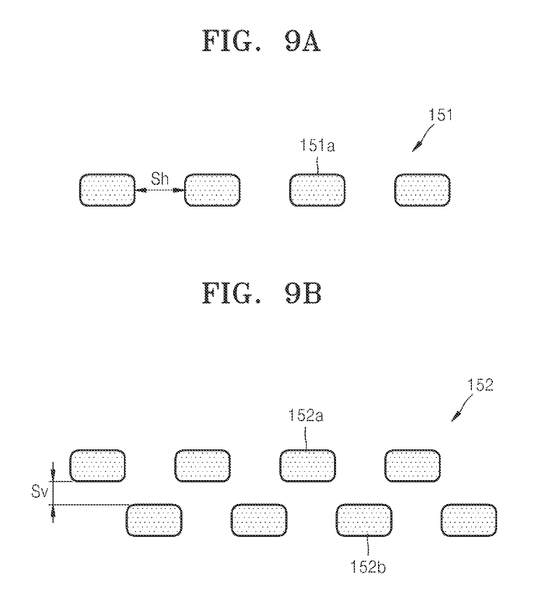

FIGS. 9A and 9B illustrate tip portions 151 and 152 of the charging electrode 110 according to an embodiment of the present general inventive concept. Referring to FIG. 9A, the tip portion 151 is formed in a dotted line in which a group of nano structures constitutes islands 151a, and the islands 151a may be non-continuous islands and may be arranged in a row at equal intervals. Each of the islands 151a includes the porous insulating layer 140 and the nano structure 130 disposed in the plurality of hollow rods 140a of the porous insulating layer 140, as illustrated in FIG. 6. The hollow rods 140a may be represented by dots of the respective islands 151a and may be disposed on corresponding dotted lines of the respective islands 151a. In this case, the islands 151a may be spaced-apart from each other by a predetermined distance Sh. The size of each of the islands 151a or the predetermined distance Sh between the islands 151a may vary according to a design of the charging device 100 of FIG. 1. When the nano structure 130 has the arrangement of the non-continuous islands 151a, due to an effect that occurs at a boundary surface between the islands 151a, the strength of an electric field near each of the islands 151a is relatively increased as compared to the same charging voltage. Since a charging operation of the charging device 100 can be performed with a charging start voltage, and the strength of an electric field near each of the islands 151a is relatively increased, the charging operation can be performed with a low charging start voltage. As such, the charging start voltage may be reduced. Furthermore, an inclination of the graph representing the strength of the electric field is increased so that an area in which a discharge product such as ozone or a nitrogen oxide is generated may be reduced. On the other hand, in the current embodiment, although the tip portion 151 is not formed continuously, charging may be uniform by using the grid electrode (190 of FIG. 1). In this case, the grid electrode 190 may be connected to the nano structure 130 while passing an area in which the dotted line shape of the tip portion 151 is projected, or while passing an area other than the area in which the dotted line shape of the tip portion 151 is projected. For example, a surface on which the grid electrode 190 is disposed in a plane formed in the first and second directions x and y is installed in the charging electrode 110 to maintain a predetermined distance in the third direction from the islands 151a or to be spaced apart from a surface of the islands 151a by the predetermined distance. In this case, the grid holder 180 may be disposed to hold or support grids of the grid electrode 190 to have a gap between the grids and a top surface of the islands 151a which protrude from the substrate 120 in the third direction z.

Referring to FIG. 9B, the tip portion 152 may include islands 152a and 152b which include a group of nano structures to be arranged in two rows. The two-row islands 152a and 152b are alternately arranged while being separated from each other by a predetermined distance Sv in the second direction y. In each of the two-row islands 152a and 152b, islands 152 or 15b can be spaced-apart from each other by a distance, fore example, distance Sh in the first direction x. In the current embodiment, as the two-row islands 152a and 152b are alternately arranged, the non-uniformity of charging caused by non-continuous arrangement of the one-row islands 152a may be reduced or prevented by the other-row islands 152b so that uniformity of charging may be obtained. Furthermore, the charging device 100 of FIG. 1 may further include the grid electrode 190 so that uniformity of charging may be improved.

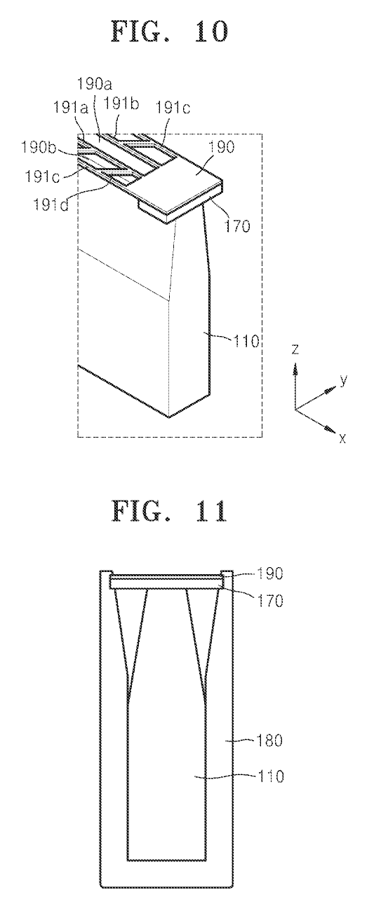

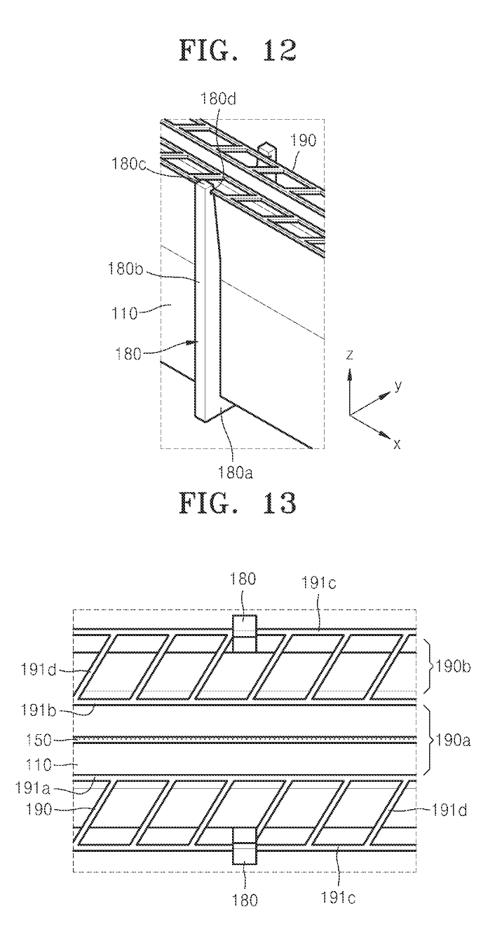

Next, the grid electrode 190 and a structure to support the grid electrode 190 will be described with reference to FIGS. 10 through 13. FIG. 10 is an enlarged view of a region C of FIG. 2, and FIG. 11 is a partial top view of the region C of FIG. 2. FIG. 12 is an enlarged view of a region D of FIG. 2, and FIG. 13 is a side view of the region D of FIG. 2.

Referring to FIGS. 2 through 13, the grid electrode 190 may be formed in such a way that the area in which the tip portion 150 is projected is opened. However, the present invention is not limited thereto, and the grid structure 190 may be connected to the charging electrode 110 while passing an area in which the tip portion 150 is projected.

The grid electrode 190 is separated from the tip portion 150 of the charging electrode 110 by a distance of several tens of μm to several mm. The spacer 170 is disposed at both ends of the substrate 120 and supports the grid electrode 190. The spacer 170 is formed of material having an insulation property. FIG. 1 illustrates the case that the spacer 170 is formed on the top surface of the substrate 120. However, the present invention is not limited thereto. For example, the porous insulating layer 140 may be formed on all portions of the top surface of the substrate 120, and the spacer 170 may be disposed on the porous insulating layer 140.

In order to separate the grid electrode 190 from the tip portion 150 at equal intervals, the grid holder 180 may be disposed in the middle of the grid electrode 190 to support the grid electrode 190. An optimum distance between the grid electrode 190 and the tip portion 150 may be determined according to a diameter of the nano structure (130 of FIG. 1) or a distance between the nano structures 130.

The charging device 100 of FIG. 1 may finely adjust the distance between the grid electrode 190 and the tip portion 150 by using the spacer 170 and the grid holder 180. As such, the charging device 100 may be designed according to a fine charging characteristic of the nano structure 130 of the tip portion 150.

The grid electrode 190 may include a structure having a frame formed with grids 191a and 191b to define one or more openings 190a and also formed with grids 191c and 191d to define one or more openings 190b with the grids 191a and 191b.

The grid holder 180 may include a first portion 180a, a second portion 180b extended from the first portion 180a to surround the substrate and/or a portion of the nano electrode 130, and a third portion 180c to hold and support the grids. The third portion 180c may include a distal end or clip-structure 180d to support the grids with respect to the nano electrode 130.

Next, an operation of the charging device 100 will be described with reference to FIG. 1.

The charging device 100 charges the layer 15 of the object 10 by using a corona discharge. The corona discharge is a phenomenon in which insulation of a dielectric substance is partially destroyed in an area to which a predetermined strength of an electric field is applied, gaseous particles are ionized and a current flows. In the charging device 100, the nano structure 130 including a plurality of sharp nano rods 130 constitutes a tip portion of the charging electrode 110. Thus, the strength of an electric field is particularly increased near ends of the nano rods 130a. Thus, the corona discharge occurs near the ends of the nano rods 130a. The ionized gaseous particles are moved to the object 10 due to an electric field applied between the charging electrode 110 and the object 10 and collide with the surface of the object 10, i.e., the layer 15, so that the layer 15 may be charged. On the other hand, the ionized gaseous particles that pass through the grid electrode 190 may be controlled according to the adjustment voltage Vg applied to the grid electrode 190, and a path along which the ionized gaseous particles are moved may be adjusted so that uniformity of charging may be improved. To this end, the charging voltage Ve is applied to the charging electrode 110, and the adjustment voltage Vg that is lower than the charging voltage Ve is applied to the grid electrode 190. On the other hand, a lower voltage than the charging voltage Ve and the adjustment voltage Vg is applied to the support 11 of the object 10. For example, a charging voltage of −5000 V is applied to the charging voltage 110, a voltage of −600 V is applied to the grid electrode 190, and a voltage of −500 V is applied to the support 11 of the object 10.

The layer 15 of the object 10 is moved in the second direction y that is a widthwise direction of the charging electrode 10. For example, when the object 10 has a cylindrical shape such as a photosensitive drum, as the object 10 is rotated, the layer to be charged 15 may be moved in a circumference direction. As described above, due to the electric field applied between the charging electrode 110 and the object 10, the ionized gaseous particles collide with the layer 15 to charge the layer 15, and as the layer 15 is moved, all portions of the layer 15 may be charged.

In the charging device 100 of FIG. 1, the tip portion of the charging electrode 110 includes the plurality of sharp nano rods 130a. Thus, a discharge characteristic may be improved so that a corona discharge may easily occur even at a low charging voltage. Also, although the amount of charging of each of the nano rods 130a is small, the nano structure 130 is formed of the plurality of nano rods 130a so that a sufficient amount of charging may be performed.

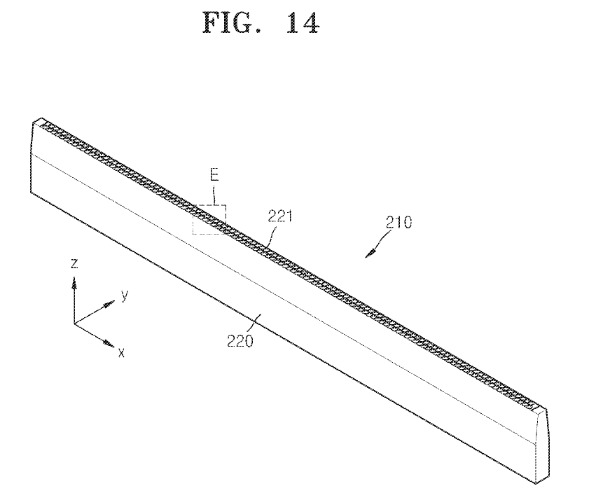

FIGS. 14 through 20 illustrate a charging device according to another embodiment of the present invention.

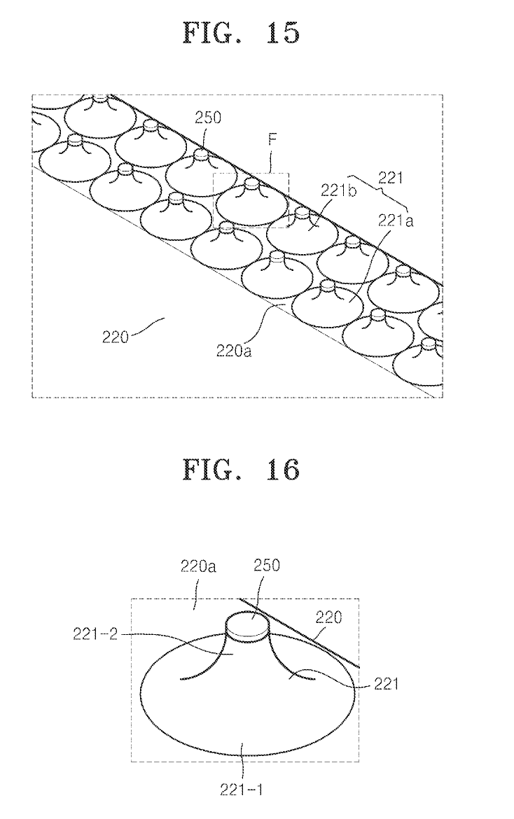

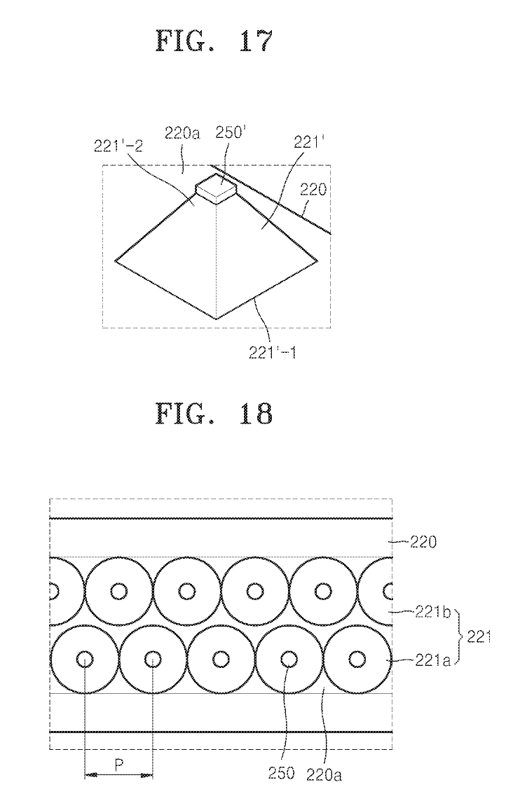

FIG. 14 is a perspective view of a charging electrode disposed in a charging device according to another embodiment of the present general inventive concept, and FIG. 15 is a partial enlarged view of a region E of FIG. 14. FIG. 16 is a partial enlarged view of a region F of FIG. 15, and FIG. 17 illustrates a protrusion according to an embodiment of the present general inventive concept. Referring to FIGS. 14 through 17, the charging device according to the present embodiment includes a substrate 220 including a plurality of protrusions 221, and a charging electrode 210 including a tip portion 250 disposed on each of the plurality of protrusions 221.

The substrate 220 may be formed of a conductive material such as a metal, for example, aluminum (Al). The plurality of protrusions 221 are formed on a top surface 220a of the substrate 220 in two rows and extend in the first direction x.

The plurality of protrusions 221 are formed of a conductive material. The plurality of protrusions 221 extend from the top surface 220a of the substrate 220 and may be formed with the substrate 220 as a one body. As occasion demands, the plurality of protrusions 221 may be separately formed from the substrate 220 and may be bonded to the top surface 220a of the substrate 220. An area of an upper portion 221-2 (221′-2) of each of the plurality of protrusions 221 is the same as or smaller than an area of a lower portion 221-1 (221′-1) of each of the plurality of protrusions 221. For example, the plurality of protrusions 221 may have a truncated conical shape, as illustrated in FIG. 10. As illustrated in FIG. 17, a protrusion 221′ may have a truncated reverse pyramidal shape. In addition, the protrusion 221′ may have a cylindrical shape, a square pillar shape or other various shapes.

A tip portion 250, 250′ is disposed at a top surface of each of the plurality of protrusions 221. The structure of the tip portion 250 may be substantially the same as the structure of the tip portion 150 described with reference to FIGS. 6 through 8. In other words, the tip portion 250 has a structure in which a nano structure is formed in hollow rods of a porous insulating layer and is supported by the porous insulating layer. Also, the hollow rods of the porous insulating layer are perforated so that the nano structures formed in the hollow rods of the porous insulating layer may be electrically connected to the protrusions 221. The plurality of protrusions 221 and the tip portion 250 may be formed by using an anodizing alumina template, as described above. For example, the top surface 220a of the substrate 220 is first oxidized to form the anodizing alumina template and then, the nano structure is formed in hollow holes of the anodizing alumina template. Next, the area of the tip portion 250 is patterned in the anodizing alumina template in which the nano structure is filled, and then, the top surface 220a of the substrate 220 in portions other than the tip portion 250 is etched to form the protrusions 221 and the tip portion 250 disposed on the protrusions 221 may be formed at the top surface 220a of the substrate 220. The plurality of protrusions 221 may be formed at the top surface 220a of the substrate 220 by forging or die casting as well as photolithography, and ends of the protrusions 221 may be planarized, and then, the tip portion 250 that is separately manufactured may be attached to the protrusions 221.

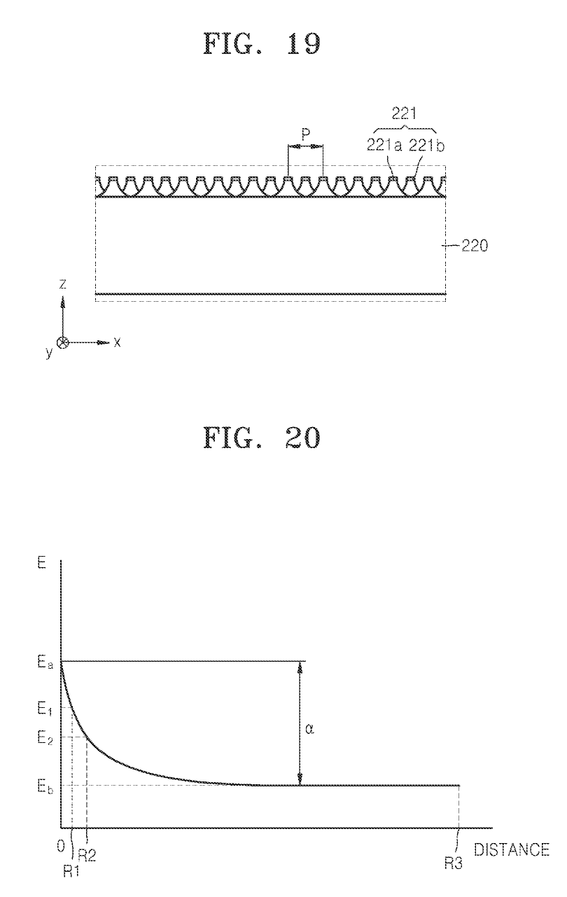

FIGS. 18 and 19 are top and side views of the region E of FIG. 14, respectively, which illustrate the arrangement of the plurality of protrusions 221. Referring to FIGS. 18 and 19, the plurality of protrusions 221 includes first row protrusions 221a and second row protrusions 221b. The tip portions or center portions of the first row protrusions 221a are separated from one another at a pitch interval P, and the tip portions or center portions of the second row protrusions 221b are separated from one another at the pitch interval P. Also, the first row protrusions 221a and the second row protrusions 221b are alternately arranged, as illustrated in FIG. 13. As the protrusions 221 are alternately arranged in two rows in this manner, the tip portions 250 that are located at ends of each of the plurality of protrusions 221 are compactly arranged in a lengthwise direction (direction x of FIG. 14). Thus, charging may be uniformly performed by using the tip portions 250 in the lengthwise direction (direction x of FIG. 14). Furthermore, the charging device according to the present embodiment may further include the grid electrode 190 described with reference to FIGS. 1 and 2 so that uniformity of charging may be further improved.

It will be understood by those of ordinary skill in the art that the greater a stepped portion on the surface of an electrode to which a voltage is applied, the greater an electric field near the electrode in which the stepped portion is formed. In the charging electrode 210 according to the present embodiment, as the tip portion 250 includes the above-described nano structure and has a protrusion structure in which the tip portion 250 is formed on the protrusions 221 of the substrate 220, an electric field that is generated due to the applied charging voltage is increased near the tip portion 250. Thus, a charging distance between the tip portion 250 and the object to be charged 10 may be sufficiently increased, and for example, a charging distance of 7 mm may be obtained.

Furthermore, as the charging electrode 210 has a protrusion structure, the distribution of electric fields between the tip portion 250 and the object 10 may be very steep or variable so that the amount of discharge products may be reduced. In other words, when the ratio of a maximum electric field strength Ea at an end of the nano structure in the tip portion 250 to a minimum electric field strength Eb in the object 10 is an electric field concentration factor α, due to the protrusion structure of the charging electrode 210, the value of the electric field concentration factor α is increased.

FIG. 20 illustrates the distribution of electric fields between the charging electrode 210 and the object to be charged 10. A position having a distance value of 0 denotes a tip portion (250 of FIG. 15), and a distance R3 denotes the surface of an object such as a photoreceptor (10 of FIG. 1). Referring to FIG. 20, the maximum electric field strength Eₐ occurs at the position 0 that is the closest to the tip portion 250, i.e., the end of the nano structure. An electric field strength is rapidly decreased according to a distance from the tip portion 250, and a nearly uniform minimum electric field strength E_{b} occurs near the object to be charged 10. The maximum electric field strength Eₐ has at least a value of 3 MV/m that is an ionization electric field strength E₁ of air, and the minimum electric field strength E_{b} has a smaller value than 1.25 MV/m that is a dissociation electric field strength E₂ of air. In ionization regions 0 to R1 having an electric field strength between the maximum electric field strength Eₐ and the ionization electric field strength E₁, gaseous molecules of air are ionized. The ionized gaseous molecules are moved to the object 10 due to an electric field applied between the charging electrode 210 and the object 10. On the other hand, in dissociation regions R1 to R2 having an electric field strength between the ionization electric field strength E₁ and the dissociation electric field E₂, portions of the ionized gaseous molecules are combined to generate a discharge product such as ozone or a nitrogen oxide. Thus, the volume of the dissociation regions R1 to R2 may be reduced so that the amount of the discharge product may be reduced. In the current embodiment, as the charging electrode 210 has the protrusion structure, an inclination of the graph representing an electric field strength near the tip portion 250 becomes steep so that the volume of the dissociation regions R1 to R2 may be reduced. In particular, since a border region of the tip portion 250 disposed at the end of each protrusion 221 is stepped or has a step-like structure, an inclination of the graph representing an electric field strength is more steep than in a central region of the tip portion 250. The inclination of the graph representing an electric field strength may be indicated by the value of the electric field concentration factor α. The electric field concentration factor α may be varied according to the shape of the end of the protrusion 221 or an interval of the arrangement of the protrusions 221. In the current embodiment, the charging electrode 210 has the protrusion structure so that the value of the electric field concentration factor α near the central region of the tip portion 250 is equal to or greater than 3. Thus, generation of the discharge product may be prevented.

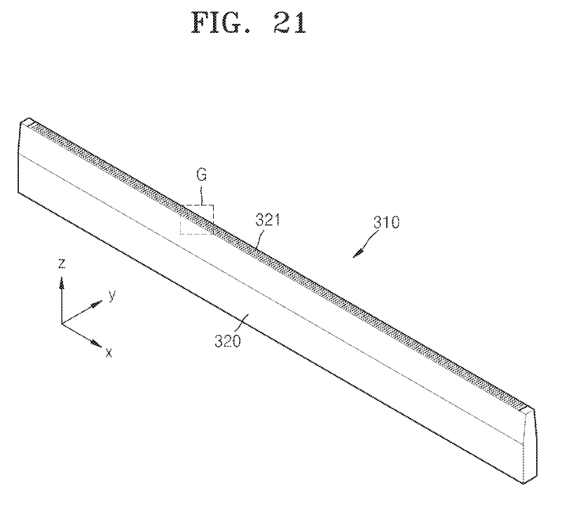

FIGS. 21 through 26 illustrate a charging device according to another embodiment of the present inventive concept.

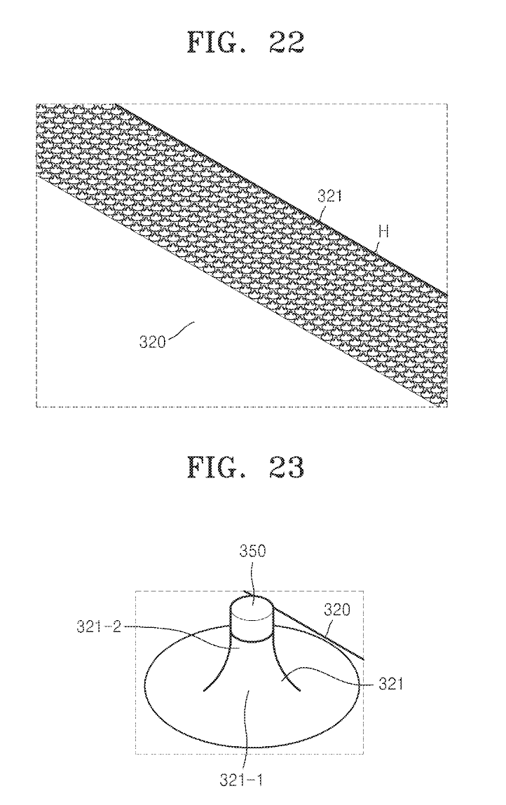

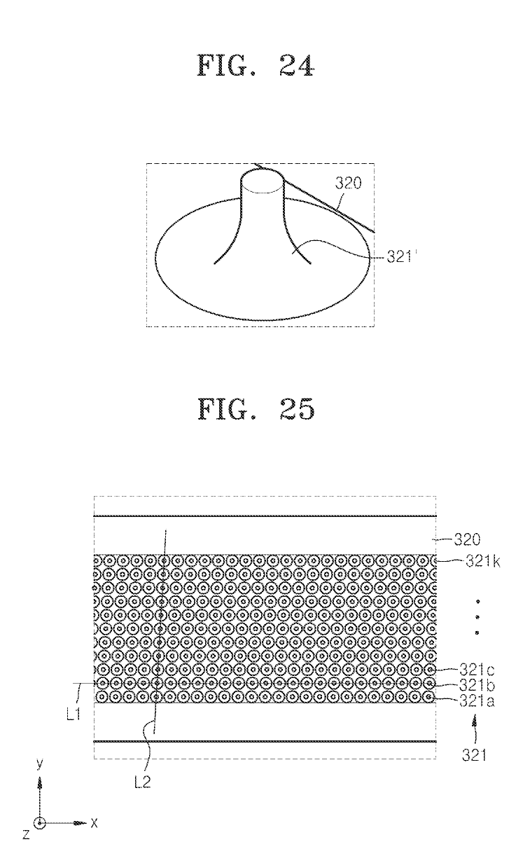

FIG. 21 is a perspective view of a charging electrode 310 disposed in a charging device according to another embodiment of the present general inventive concept, and FIG. 22 is a partial enlarged view of a region G of FIG. 21. FIG. 23 is a partial enlarged view of a region H of FIG. 22, and FIG. 24 illustrates a protrusion according to an embodiment of the present general inventive concept. The charging device according to the present embodiment is substantially the same as the charging device described with reference to FIG. 14 except for the structure of protrusions, and thus, only the structure of the protrusions will be described below.

Referring to FIGS. 21 through 23, a substrate 320 is formed of a conductive material, and the charging device has a two-dimensional arrangement structure in which a plurality of protrusions 321 are arranged in eleven (11) rows and extend from a top surface 320a of the substrate 320 in a first direction x.

The plurality of protrusions 321 are formed of a conductive material and may extend from the top surface 320a of the substrate 320 and may be formed with the substrate 320 as one body. As occasion demands, the plurality of protrusions 321 may be separately formed from the substrate 320 and may also be bonded to the top surface 320a of the substrate 320. An area of an upper portion 321-2 of each of the plurality of protrusions 321 is the same as or smaller than an area of a lower portion 321-1 of each of the plurality of protrusions 321. For example, the plurality of protrusions 321 may have a truncated conical shape, as illustrated in FIG. 23. In addition, the protrusions 321 may have a truncated reverse pyramidal shape, a cylindrical shape or a square pillar shape.

A tip portion 350 is disposed at a top surface of each of the plurality of protrusions 321. The structure of the tip portion 350 may be substantially the same as the structure of the tip portion 150 described with reference to FIGS. 6 through 8. In other words, the tip portion 350 has a structure in which nano structures are formed in hollow rods of a porous insulating layer and the nano structures are supported by the porous insulating layer. Also, the hollow rods of the porous insulating layer are perforated so that the nano structures formed in the hollow rods of the porous insulating layer may be electrically connected to the protrusions 321. The plurality of protrusions 321 and the tip portion 350 may be formed by using an anodizing alumina template, as described above. The structure of the protrusions 321 and the tip portion 350 may be understood as a reduction shape of the protrusions 221 and the tip portion 250 described with reference to FIGS. 16 and 17.

Furthermore, the protrusion structure of a charging electrode 310 is not limited to the shape described above, and there may not be an additional nano structure. FIG. 24 illustrates a protrusion 321′ according to an embodiment of the present general inventive concept. Referring to FIG. 24, the protrusion 321′ extends from the substrate 320 and constitutes a tip portion of the charging electrode 310. As described above, the protrusion structure of the charging electrode 310 according to the present embodiment is an array structure in which protrusions 321′ are two-dimensionally arranged in the top surface 320a of the substrate 320. Thus, the protrusions 321′ may serve as a tip that is substantially small. For example, when a width of the top surface 320a of the substrate 320 in a second direction (y of FIG. 21) is about 1 mm, if the protrusions 321′ are arranged in 10 or more rows in the second direction y, each of the protrusions 321′ is less than 100 μm, and an end of each of the protrusions 321′ becomes smaller so that an electric field strength may be increased at the end of each of the protrusions 321′ and the value of an electric field concentration factor α may be set to 3 or more.

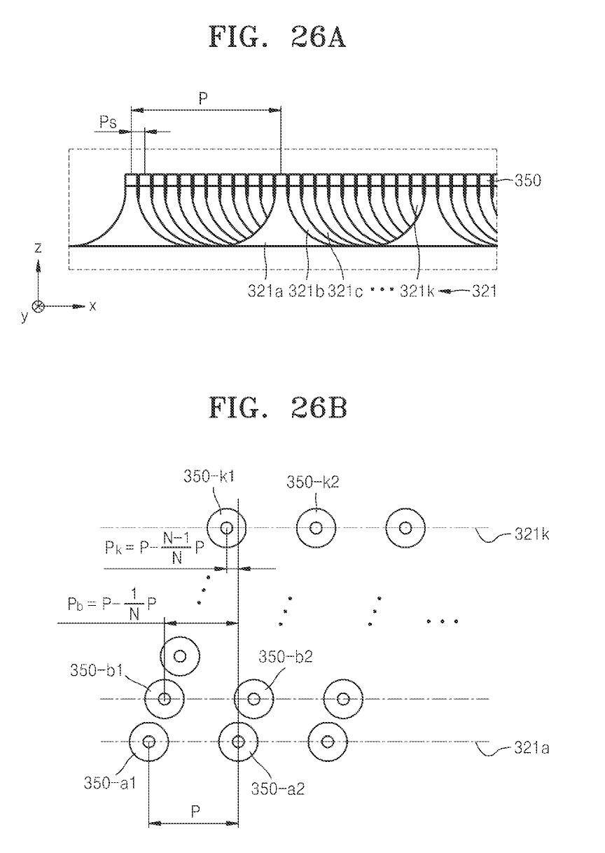

FIGS. 25 and 26A are top and side views of the region G of FIG. 21, respectively, which illustrate the structure of arrangement of the plurality of protrusions 321. Referring to FIGS. 25 and 26, the plurality of protrusions 321 include first through eleventh row protrusions 321a, 321b, 321c, . . . , and 321k. A direction L1 in each of the rows of the first through eleventh row protrusions 321a, 321b, 321c, . . . , and 321k is parallel to the first direction x. The tip portions of the first through eleventh row protrusions 321a, 321b, 321c, . . . , and 321k are separated from one another in the first direction x at a pitch interval P. On the other hand, each of the rows of the first through eleventh protrusions 321a, 321b, 321c, . . . , and 321k is arranged to have a difference Ps of the arrangement of neighboring rows with respect to the first direction x. The difference Ps may be obtained by using Equation 1:

Ps=P/N (1),

, where N is the number of rows in which the protrusions 321 are arranged. In the current embodiment, N is 11. As a result, a segment L2 that connects the adjacent protrusions 321 in the second direction y may not be exactly consistent with the second direction y and may be slightly inclined or having an angle with the second direction y. Also, the first through eleventh row protrusions 321a, 321b, 321c, . . . , and 321k are arranged in the first direction x at one pitch interval P, as illustrated in FIG. 26. In other words, the protrusions 321 are arranged in the first direction x at one pitch interval P. In this way, the protrusion 321 has one pitch interval P with the adjacent protrusion 321. However, when viewed from an object to be charged such as a photoreceptor (10 of FIG. 1), the protrusions 321 are arranged in the first direction x at a density that is eleven times greater than a density at which the first row protrusions 321 are arranged. Thus, the tip portions 350 are more compactly arranged in the first direction x so that the object to be charged 10 may be charged uniformly. In the charging device according to the present embodiment, a very high electric field strength near the tip portion 350 of the charging electrode 310 may be obtained, and uniformity of compact charging may be obtained due to the two-dimensional arrangement structure. As such, a charging distance between the tip portion 350 of the charging electrode 310 and the object to be charged 10 may be set to be less than 1 to 4 mm in consideration of a design tolerance. In addition, a charging start voltage may be reduced, and the amount of ozone generated may be greatly reduced.

Referring to FIG. 26B, a plurality of first groups of tip portions are disposed on corresponding lines 321a, . . . 321k. For example, adjacent ones of the first group tip portions 350-a1 and 350-a2 are disposed on the line 321a in a direction, and another adjacent ones of the first group tip portions 350-k1 and 350-k2 are disposed on the line 321k in the direction. The tip portions (or center portion of the tip portions) of the first group are spaced apart from each other by an interval P. The second group tip portions 350-a1, 350-b1, 350-k1 are disposed in another direction within the interval P. The second group tip portions are spaced apart from each other by another interval. The another direction and a line connecting the tip portions 350-a2 and 350-k2 are disposed to have an angle. Accordingly, the tip portion 350-b1 is disposed to have a distance Pb=P−P/N with the line. Here, P is an interval, and N is the number of the second group tip portions disposed in the interval P. One of the tip portions has a distance Pk-1=P−(N−1)P/N, for example. The tip portions 250-a1, 350-b1, . . . 350-k1 may have a distance with the line by the above describe distance according to a distance from the first group tip portion 350-a1 or 350-a2.

In addition, in the charging device according to the present embodiment a sufficient uniformity of charging may be obtained without including a grid electrode due to the compact two-dimensional arrangement structure of the plurality of protrusions 321, and a grid electrode (190 of FIG. 2) may be additionally included in the charging device so as to more easily control a charging voltage.

In the present embodiment, the protrusions 321 have the two-dimensional arrangement structure in which the protrusions 321 are arranged in 11 rows. However, the present invention is not limited thereto. For example, the protrusions 321 may have a two-dimensional arrangement structure in which the protrusions 321 are arranged in the number of rows that is smaller or greater than 11 and may also have an irregular arrangement structure.

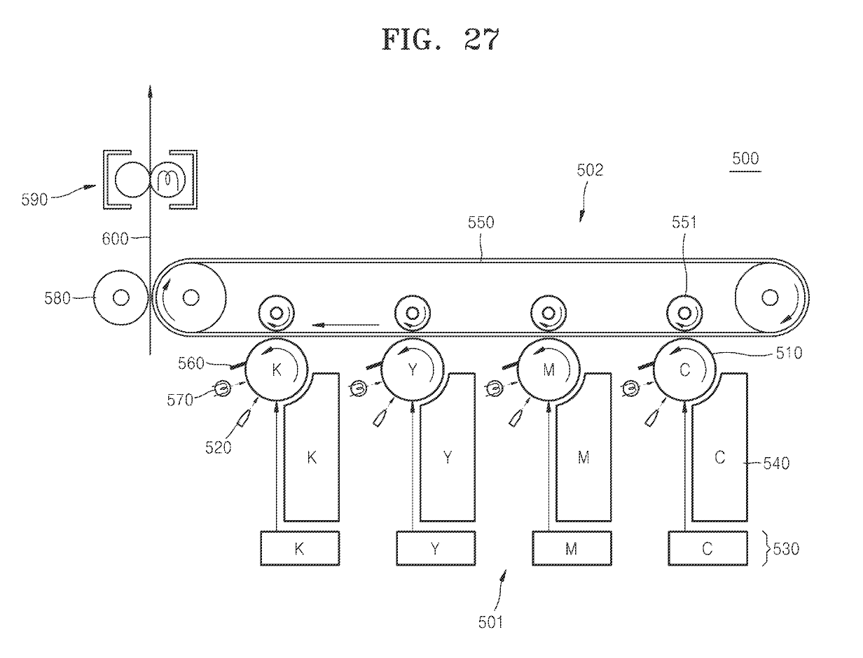

FIG. 27 is a schematic view of an electrophotographic image forming apparatus including a charging device, according to an embodiment of the present general inventive concept. Referring to FIG. 27, the electrophotographic image forming apparatus includes an image developing unit 501 which includes a photosensitive drum 510, a charging device 520, a light scanning unit 530, a developing unit 540, a cleaning unit 560, and an electrostatic charge-removing unit 570, and an image transfer unit 502 which includes an intermediate transfer belt 550, first and second transfer rollers 551 and 580, and a fusing unit 590.

In order to print a color image, the photosensitive drum 510, the charging device 520, the light scanning unit 530, the developing unit 540, the cleaning unit 560, and the electrostatic charge-removing unit 570 may be provided according to color. The photosensitive drum 510 disposed for color such as black (K), magenta (M), yellow (Y) or cyan (C) is an example of a photoreceptor and is a photosensitive layer formed at an outer circumferential surface of a cylindrical metal pipe to a predetermined thickness. A photosensitive belt may be employed as the photoreceptor. The outer circumferential surface of the photosensitive drum 510 is a surface to be scanned. The charging device 520 charges the surface of the photosensitive drum 510 at a uniform electric potential, and a charging device according to the afore-mentioned embodiments may be used as the charging device 520. A charging voltage is applied to the charging device 520. The light scanning unit 530 scans a light beam that is modulated according to image information on the photosensitive drum 510 in a main scanning direction. As the light beam is scanned on the surface to be scanned of the photosensitive drum 510 of which surface is charged by the charging device 520 at a uniform electric potential, an electrostatic latent image is formed. In this case, the surface to be scanned is moved in an auxiliary scanning direction as the photosensitive drum 510 is rotated, and the light scanning unit 530 scans the light beam on the surface to be scanned of the photosensitive drum 510 in the main scanning direction while being synchronized with a horizontal synchronous signal so that a two-dimensional electrostatic latent image may be formed on the surface to be scanned of the photosensitive drum 510.

An electrostatic latent image that corresponds to image information about black (K), magenta (M), yellow (Y), and cyan (C), respectively, is formed on each of four photosensitive drums 510. Each of the four developing units 540 supplies a toner of color such as black (K), magenta (M), yellow (Y), and cyan (C) to the photosensitive drum 510 to develop a toner image of color such as black (K), magenta (M), yellow (Y) or cyan (C). The intermediate transfer belt 550 travels in contact with the four photosensitive drums 510. The toner images of color such as black (K), magenta (M), yellow (Y), and cyan (C) formed on each of the photosensitive drums 510 are transferred onto the intermediate transfer belt 550 due to a first transfer bias voltage applied to the first transfer roller 551 and are overlapped on the intermediate transfer belt 550. A drum type intermediate transfer belt, instead of the intermediate transfer belt 550 may be employed. The remaining toner images after a transfer operation are removed by the cleaning unit 570. Also, an electrostatic-removing operation is performed on the surface of the photosensitive drum 510 in which the transfer operation is completed, so that a developing operation of one cycle is performed. The toner image transferred onto the intermediate transfer belt 550 is transferred onto a recording medium 600 on the intermediate transfer belt 550 due to a second transfer bias voltage applied to the second transfer roller 580. The toner image transferred onto the recording medium 600 is fused on the recording medium 600 by the fusing unit 590 due to heat and pressure so that a printing operation may be completed.

In the above-described embodiments, the photosensitive drum 10 is used as an object to be charged. However, the present invention is not limited thereto, and the photosensitive drum 10 may be used in a transfer operation.

In the electrophotographic image forming apparatus including the charging device according to the present invention, the above-mentioned fusing unit is used so that a charging start voltage may be reduced and the amount of total current required in discharging may be reduced. Also, the amount of a discharge product such as ozone or a nitrogen oxide may be reduced, and uniformity of charging may be improved.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A charging device comprising:
a substrate formed of a conductive material;
a porous insulating layer disposed on the substrate and comprising a plurality of hollow rods vertically formed on the substrate;
a nano structure formed in the plurality of hollow rods, having conductivity and electrically and mechanically connected to the substrate;
a grid electrode separated from the nano structure; and
a spacer to support both ends of the grid electrode.

2. The device of claim 1, wherein the substrate comprises metal.

3. The device of claim 1, wherein a horizontal cross-section of the substrate that is parallel to a surface on which the porous insulating layer is formed has a rectangular shape in which a length corresponding to a width of an object to be charged in a first direction is relatively long and a width in a second direction that is perpendicular to the first direction is relatively short.

4. The device of claim 3, wherein a length of the substrate having the rectangular shape in the first direction is uniform regardless of a third direction that is perpendicular to the first and second directions and a width of the substrate having the rectangular shape in the second direction is decreased as it gets closer to a top surface of the substrate in the third direction or is uniform.

5. The device of claim 4, wherein a length of the substrate in the third direction is equal to or greater than a maximum width of the substrate in the second direction.

6. The device of claim 1, wherein the substrate comprises a plurality of protrusions protruding from the top surface of the substrate, and the porous insulating layer is formed on a top surface of each of the plurality of protrusions.

7. The device of claim 6, wherein the plurality of protrusions are arranged in a row in a dotted line at equal intervals.

8. The device of claim 6, wherein the plurality of protrusions are arranged in a plurality of rows in a dotted line at equal intervals and are alternately arranged between the plurality of neighboring rows.

9. The device of claim 8, wherein, when the number of rows of the plurality of protrusions is N and a pitch interval between the protrusions in each of the rows is P, the protrusions between the neighboring rows are alternately arranged at a difference of P/N.

10. The device of claim 6, wherein each of the plurality of protrusions has a shape in which an area of a surface on which the porous insulating layer is to be formed is equal to or smaller than an area of a surface on which the substrate is to be formed.

11. The device of claim 1, wherein the porous insulating layer is a nanoporous template.

12. The device of claim 11, wherein the nanoporous template is an anodizing alumina template or a polymer nano template.

13. The device of claim 1, wherein the nano structure is a metal nano rod that fills the hollow rods of the porous insulating layer or carbon nanotubes that are grown in the hollow rods of the porous insulating layer.

14. The device of claim 1, wherein the nano structure fills the hollow rods of the porous insulating layer or portions thereof.

15. The device of claim 1, wherein the nano structure is in the shape of a continuous strip on the substrate.

16. The device of claim 15, wherein an area of the grid electrode that corresponds to the continuous line shape of the nano structure is opened.

17. The device of claim 1, wherein a group of nano structures constitutes non-continuous islands, and the islands are arranged in a row on the substrate in a dotted line at equal intervals.

18. The device of claim 17, wherein the grid electrode is connected to the nano structure while passing an area in which the dotted line shape of the nano structure is projected, or while passing a reverse image of the area in which the dotted line shape of the nano structure is projected.

19. The device of claim 1, wherein a group of nano structures constitutes non-continuous islands, and the islands are arranged in a plurality of rows on the substrate in a dotted line at equal intervals, and the islands are alternately arranged between the neighboring rows.

20. The device of claim 1, wherein the spacer is interposed between the grid electrode and the substrate or between the grid electrode and the porous insulating layer.

21. The device of claim 1, wherein the spacer comprises an insulating material.

22. The device of claim 1, further comprising at least one grid holder disposed between both ends of the grid electrode and supporting the grid electrode while being inserted or fixed in the substrate.

23. The device of claim 1, further comprising a voltage source applying a charging voltage to the substrate and applying an adjustment voltage to the grid electrode, wherein an absolute value of the adjustment voltage is smaller than an absolute value of the charging voltage.

24. A charging device that charges an object, the device comprising:
a substrate formed of a conductive material; and
a plurality of protrusions two-dimensionally arranged on the substrate and having conductivity to charge the object.

25. The device of claim 24, further comprising:
a porous insulating layer disposed on a top surface of each of the plurality of protrusions and comprising a plurality of hollow rods vertically formed on the top surface of each of the protrusions; and
a nano structure formed in the plurality of hollow rods, having conductivity and electrically and mechanically connected to the substrate.

26. The device of claim 24, wherein the plurality of protrusions are arranged in a plurality of rows in a dotted line at equal intervals and are alternately arranged between the plurality of neighboring rows.

27. The device of claim 26, wherein, when the number of rows of the
plurality of protrusions is N and a pitch interval between the protrusions in each of the rows is P, the protrusions between the neighboring rows are alternately arranged at a difference of P/N.

28. The device of claim 28, wherein each of the plurality of protrusions
has a shape in which an area of a surface on which the porous insulating layer is to be formed is equal to or smaller than an area of a surface on which the substrate is to be formed.

29. The device of claim 24, wherein the substrate comprises metal.

30. The device of claim 24, wherein the porous insulating layer is an anodizing alumina template or a polymer nano template.

31. The device of claim 24, wherein the nano structure is a metal nano rod that fills the hollow rods of the porous insulating layer or carbon nanotubes that are grown in the hollow rods of the porous insulating layer.

32. An electrophotographic image forming apparatus comprising:
a photoreceptor;
a charging device charging an outer surface of the photoreceptor;
a light scanning unit scanning light onto the outer surface of the photoreceptor to form an electrostatic latent image; and
a developing unit supplying a toner to the electrostatic latent image formed on the photoreceptor to develop a toner image,
wherein the charging device comprises:
a substrate formed of a conductive material;
a porous insulating layer disposed on the substrate and comprising a plurality of hollow rods vertically formed on the substrate;
a nano structure formed in the plurality of hollow rods, having conductivity and electrically and mechanically connected to the substrate;
a grid electrode separated from the nano structure; and
a spacer to support both ends of the grid electrode.

33. An electrophotographic image forming apparatus comprising:
a photoreceptor;
a charging device to charge an outer surface of the photoreceptor;
a light scanning unit to scan light onto the outer surface of the photoreceptor to form an electrostatic latent image; and
a developing unit to supply a toner to the electrostatic latent image formed on the photoreceptor to develop a toner image,
wherein the charging device comprises:
a substrate formed of a conductive material; and
a plurality of protrusions two-dimensionally arranged on the substrate and having conductivity to charge the photoreceptor.

34. The apparatus of claim 33, further comprising:
a porous insulating layer disposed on a top surface of each of the plurality of protrusions and comprising a plurality of hollow rods vertically formed on the top surface of each of the protrusions; and
a nano structure formed in the plurality of hollow rods, having conductivity and electrically and mechanically connected to the substrate.
